(19) United States
(12) Patent Application Publication
(10) Pub. No.: US 2025/0207284 A1
(43) Pub. Date: Jun. 26, 2025

(54) GROWTH OF VERTICALLY-ALIGNED NANOWIRES ON CONDUCTIVE SURFACES

(71) Applicant: CARNEGIE MELLON UNIVERSITY, Pittsburgh, PA (US)

(72) Inventors: SHENG SHEN, Pittsburgh, PA (US); RUI CHENG, Pittsburgh, PA (US)

(73) Assignee: CARNEGIE MELLON UNIVERSITY, Pittsburgh, PA (US)

(21) Appl. No.: 18/852,165

(22) PCT Filed: May 9, 2023
(86) PCT No.: PCT/US23/21452

§ 371 Date: Sep. 27, 2024

Related U.S. Application Data
(60) Provisional application No. 63/341,796, filed on May 13, 2022.

(51) Int. Cl. C25D 1/00; C25D 1/04

(52) U.S. Cl. CPC C25D 1/006; C25D 1/04

(57) ABSTRACT

Disclosed herein is a method for fabricating a nanowire array on an uneven or curved surface. A pliable, porous scaffold is used to hold a liquid electrolyte, creating s semi-solid electrolyte that is used to transfer pressure to a template disposed on the target surface to cause the template to conform to and bond with the target surface to substantially eliminate the gap therebetween, such that a robust and controllable growth of the nanowire array can be realized.

### RELATED APPLICATIONS

This application claims the benefit of U.S. Provisional Patent Application No. 63/341,796, filed May 13, 2022, the contents of which are incorporated herein in their entirety.

### BACKGROUND

Vertically aligned metal nanowire arrays have attracted great interest because of its extraordinary thermal, mechanical, electrical, optical and chemical properties. Driven by a variety of applications in battery, thermal management, electronics, and solar energy conversion, significant efforts have been invested towards developing simple, inexpensive and robust fabrication methods. Among them, electrochemical deposition methods based on the anodic aluminum oxide or track-etched polycarbonate template are the most commonly adopted approaches, in which free-standing nanowires grow on either a conductive seed layer pre-deposited on one side of the template or a flat conductive substrate to which the template can be tightly attached.

Directly growing nanowires on an existing object with curved or rough conductive surface, even with a roughness of just a few microns, remains challenging. As shown in FIG. 1A, when the template remains flat as original and is not pre-deformed to follow the morphology of a rough surface 100, gaps 104 will be left between the surface and the template 102 even if the template has been closely attached to the surface. Especially for a rigid/fragile template (e.g., anodic aluminum oxide), it intrinsically cannot be pre-deformed/bended to follow the rough/curved surface, so that would inevitably leave gaps. In such instances, a thick parasitic metal film is usually electrochemically deposited to fill gaps 104 between template 102 and the target surface 100 in the non-flat regions before the electrodeposited material grows into the pores of the template. This process requires a significant time investment and results in a non-uniform growth of nanowires. On the other hand, as shown in FIG. 1B, even if the template 102 is soft (e.g., track-etched polycarbonate) and already pre-pressed to deform to follow the rough morphology with the target surface 100, leaving minor gaps, the template 102 cannot stay attached to the target surface 100 when the external pressure is released. Instead, the template 102 tends to bulge and detach from the surface after being immersed in the electrolyte during the electrodeposition process, forming even larger gaps to be filled before the electrodeposited material grows into the pores of the template.

### SUMMARY

To address the issues identified above, disclosed herein is a robust fabrication method to directly grow metal nanowire arrays on an uneven surface using a semi-solid electrolyte having pressure applied thereto to cause the template to conform and stay attached to the target surface during the electrodeposition process. The method is applicable regardless of the size, shape or roughness of the substrate surface. The method also is operational to grow nanowires on curved surfaces.

### BRIEF DESCRIPTION OF THE DRAWINGS

By way of example, a specific exemplary embodiment of the disclosed system and method will now be described, with reference to the accompanying drawings, in which:

FIG. 1A is an illustration showing the challenges associated with growing nanowires on an uneven surface in which a thick parasitic metal film is electrochemically deposited to fill the gaps between the template and the target surface in the non-flat regions before growth of the nanowires. FIG. 1B is an illustration showing a prior art solution in which the template is pre-deformed to comply with the uneven surface, showing the detachment of the template after immersion in an electrolyte.

FIGS. 2A-C are illustrations of the steps of growing the metal nanowire array in accordance with the method disclosed herein.

FIG. 3 is a scanning electron microscopy (SEM) image showing a nanowire array grown on an uneven surface, showing almost no parasitic layer between the nanowires and the original surface.

FIG. 4 shows a variation of the process of FIGS. 2A-C for producing a nanowire array locally on a desired spot of a substrate.

FIG. 5A is a photograph of a nanowire array grown on a copper pillar having a rough and curved surface. FIG. 5B is a photograph showing a nanowire array grown on a larger curved or flexible surface.

### DETAILED DESCRIPTION

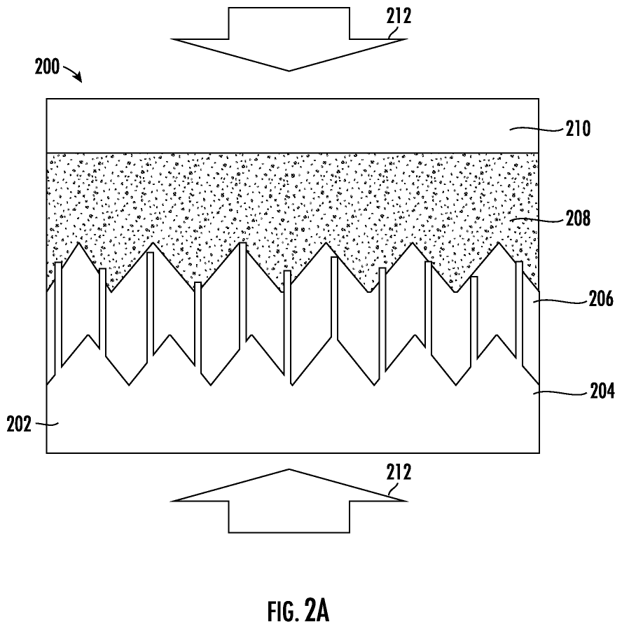

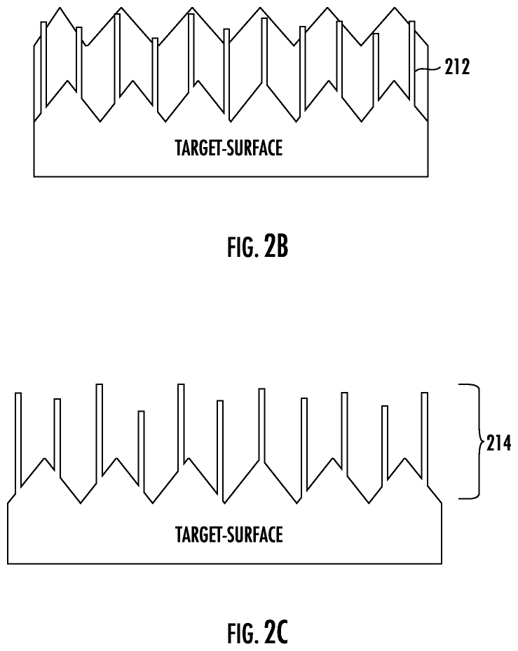

There are generally three steps in the novel fabrication process disclosed herein. In a first step, shown in FIG. 2A, a soft, pliable, porous scaffold material contains an electrolyte to form semi-solid electrolyte 208. The scaffold material may be, for example, a sponge, a foam, a fabric, paper, hydrogel, or any other soft and pliable material capable of serving as a scaffold for the liquid electrolyte. In preferred embodiments wherein the nanowire array is composed of copper nanowires, the electrolyte may based on copper sulphate (CuSO₄) or copper tetrafluoroborate (Cu(BF₄)₂) or any other electrolytes suitable for copper electrodeposition. However, other electrolytes may be used when growing nanowires composed of a material different from copper. For example, when nickel nanowires are to be deposited, correlated electrolytes like nickel sulfate (NiSO₄), nickel chloride (NiCl₂) and nickel sulfamate (Ni(SO₃NH₂)₂ etc. can be used. Other materials may also include but not limited to metal like silver, gold, brass, cadmium, chromium, iron, etc. and semiconductors like ZnS, ZnO, ZnSe, CdMnTe, CdS, ZnTe, GaSe, InSe, CdSe, CuInGaSe2, CdTe, CuInSe2, Ni(OH)₂, etc. that can be electrodeposited through solution processes.

A stacked structure 200 is created comprising a substrate 202 having a target surface 204 defined thereon, the template 206, the semi-solid electrolyte 208 and an anode 210, as shown in FIG. 2A. Preferably, the substrate 202 upon which the target surface 204 is defined is a conductive material which serves as the cathode during the growth of the nanowires. In preferred embodiments, the substrate and target surface is composed of copper, although other conductive materials may be used, for example, any other conductive metals or alloys like Fe, Ti, Ni, Zn, Ag, Au, CuZn etc., conductive semiconductors like indium doped tin oxide (ITO), fluorine-dope tin oxide (FTO), etc., and other conductive material like graphene, carbon nanotube, carbon fiber, etc., and conductive polymer materials like PEDOT: PSS, PH1000 etc.

Pressure 212 is then applied between the target surface 204 of substrate 202 and the metal anode 210. With pressure continuously applied, the semi-solid electrolyte 208 and the template 206 deform together such that the template 206 can conformally cover the rough or curved target surface 202. After a period of electrochemical deposition (i.e., on the order of tens-of-seconds) to enable the nanowire growth into pores defined in template 206, a nearly perfect bonding can be formed between the template 206 and the target surface 204.

A second step of the process is shown in FIG. 2B. In this step, the nanowires 212 are grown into template 206 by circulating the electrolytes in the porous scaffold 208 or by transferring the bonded template 206 and the substrate 202 to a traditional electroplating bath to achieve a more controllable and high-quality deposition. The length of the resulting nanowires can be precisely controlled by tuning the electroplating time. Template 206 defines a plurality of nanopores therein through which nanowires 212 are grown. Template 206 may be a commercially-available item, including but not limited to anodic aluminum oxide (AAO) and various types of track-etched polymer films such as track-etched polycarbonate (TEPC), track-etched polyester (TEPET), track-etched polyimide (TEPI), track-etched polypropylene (TEPP), track-etched polystyrene (TEPS), etc.

The last step of the process is shown in FIG. 2C in which the nanowire array (shown schematically as reference 214) is released by dissolving the template 206 using corresponding solvents or solutions without damaging or dissolving the nanowire array 214 or the substrate 202.

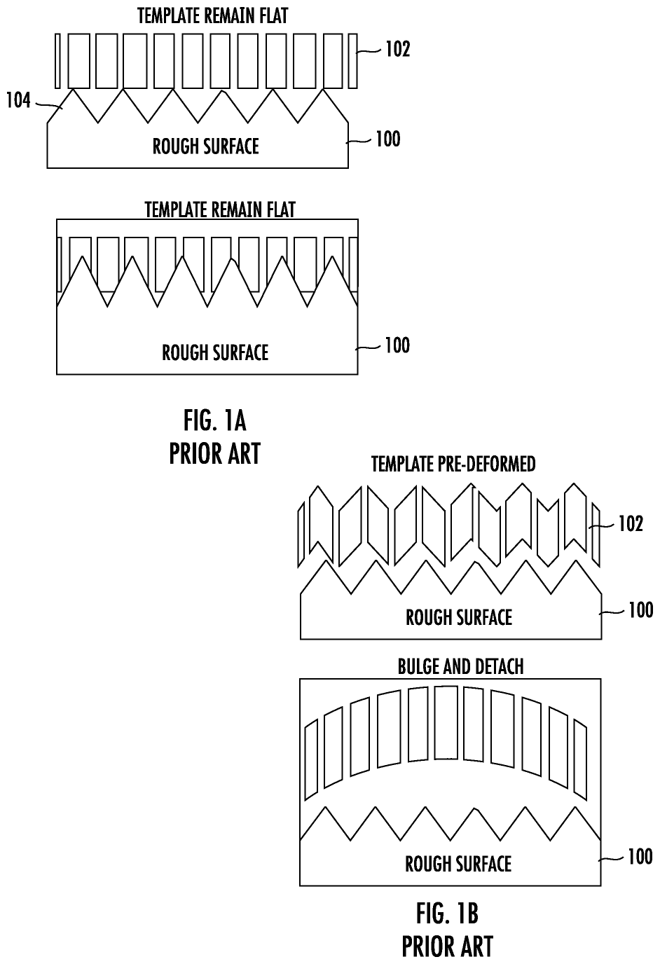

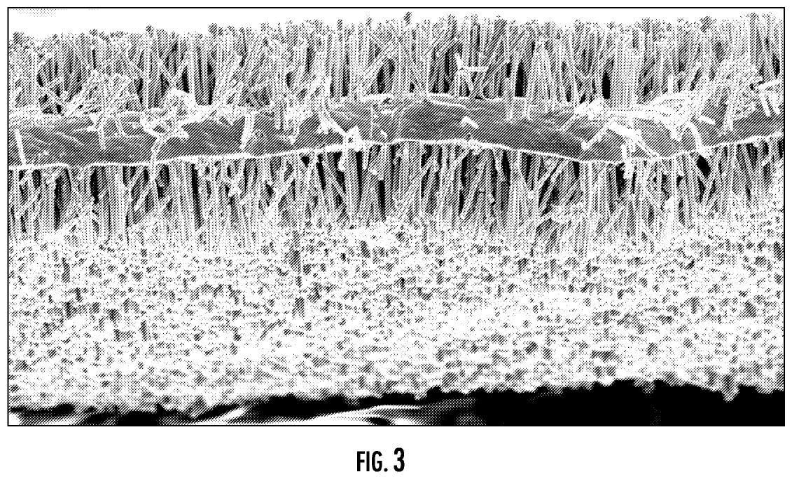

The utilization of semi-solid electrolyte 208 allows the continuous application of a constant pressure on the entire template film such that template 206 is bonded to target surface 204 during the electrochemical deposition process. This is accomplished without limitation on the morphology of target surface 204. Based on this novel method, the electroplated material directly grows into template 206 with formation of the parasitic metal film being substantially eliminated (See FIG. 1A), leading to a well-controlled process. FIG. 3 is a SEM image of a double-sided nanowire array grown in accordance with the process just described.

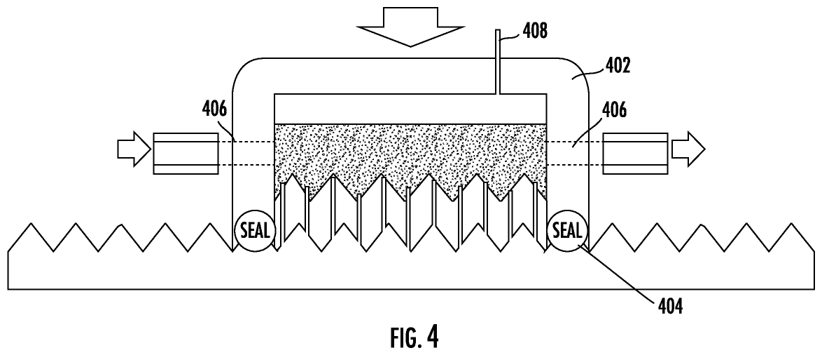

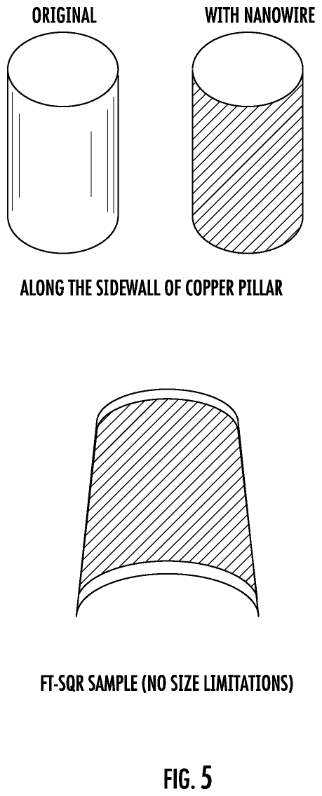

A variation of the described process may be used to grow a nanowire array locally on any desired spot of a conductive surface, as shown in FIG. 4. In this process a cover 402 is placed over the desire spot. Preferably, cover 402 is composed of materials such as PLA, PEG, PVC, although other materials may be use. The cover 402 is then sealed to target surface 204 using seal 404. Seal 404 may be composed of common material used in O-ring construction, such as rubber or silicone. Ports 406 are provided in cover 402 to allow circulation of the electrolyte. A connection 408 for anode 210 extends through cover 402. This same process also allows for the growth of vertically-aligned nanowire arrays on a variety of surfaces with different curvatures and roughness. Some examples are shown in FIG. 5. In addition, the method has no limitation on the size of the target surface, making it an industrially friendly and scalable technology. Further, the process may be used to grow nanowire arrays on opposing sides of a conductive film or sheet to create a double-sided nanowire array having the substrate disposed therebetween.

A nanowire array created by the disclosed process has many potential applications. For example, the nanowire arrays can be used as thermal interface materials, battery electrodes, supercapacitor electrodes, sensors, LEDs, triboelectric nanogenerators, catalysts, etc. Many other applications are also possible.

As would be realized by one of skills in the art, many variations on implementations discussed herein which fall within the scope of the invention are possible. For example, the method may use different materials with different shapes as the substrate and may use different electrolytes to grow nanowires of differing materials. Nanowires may have differing heights, diameters and height-to-diameter ratios. The density of the nanowires may differ, depending on the template used. Additionally, parameters of the fabrication process may vary. For example, the pressure applied to the anode and cathode to keep the template conformed to the target substrate may vary depending on application. The length of time for growing of the nanowires may also vary, depending on the application. Further, the nanowire array can be grown on substrates of any size. Many variations on both the fabricated nanowire array and the fabrication process are possible and are contemplated to be within the scope of the invention.

Moreover, it is to be understood that the features of the various embodiments described herein are not mutually exclusive and can exist in various combinations and permutations, even if such combinations or permutations were not made express herein, without departing from the spirit and scope of the invention. Accordingly, the exemplary method disclosed herein is not to be taken as a limitation on the invention but as an illustration thereof. The scope of the invention is defined by the claims which follow.

1. A method for fabricating a nanowire array, comprising:
preparing a semi-solid electrolyte comprising a pliable material used as a porous scaffold for a liquid electrolyte;
creating a stacked structure comprising a substrate having a target surface, a template disposed on the target surface, the semi-solid electrolyte disposed on the template and a metal anode disposed on the semi-solid electrolyte; and
applying pressure to the stacked structure to cause the template to conform and stay attached to the target surface.

2. The method of claim 1 further comprising:
growing a plurality of nanowires through pores defined in the template.

3. The method of claim 1 wherein the nanowires are composed of a material selected from a group consisting of copper, nickel, silver, gold, brass, cadmium, chromium, iron, etc., and semiconductors like ZnS, ZnO, ZnSe, CdMnTe, CdS, ZnTe, GaSe, InSe, CdSe, CulnGaSe₂, CdTe, CuInSe₂, Ni(OH)₂.

4. The method of claim 2 further comprising:
circulating the liquid electrolytes in the porous scaffold.

5. The method of claim 2 further comprising:
transferring the template and the substrate to an electroplating bath.

6. The method of claim 2 further comprising:
dissolving the template to release the plurality of nanowires.

7. The method of claim 1 wherein the pliable material is selected from a group consisting of sponge, fabric, foam, paper and hydrogel.

8. The method of claim 1 wherein the nanowires are formed via electrodeposition.

9. The method of claim 8 wherein the target surface is a conductive surface and further wherein the liquid electrolyte is suitable for electrodeposition.

10. The method of claim 1 where in the substrate is a conductive surface regardless of shape and roughness.

11. The method of claim 1 wherein the stacked structure further comprises a template and semi-solid electrolyte disposed on opposing surfaces of the substrate such as to concurrently grow nanowire arrays on opposing sides of the substrate.

12. The method of claim 1 wherein the target surface is uneven and further wherein the template conforms to the uneven target surface by virtue of application of the pressure.

13. The method of claim 1 wherein the target surface is curved.

14. The method of claim 2 wherein the substrate is conductive and acts as a cathode during the growth of the nanowires.

15. The method of claim 1 wherein the stacked structure can be patterned to grow nanowire array with a customizable shape and/or size.

16. The method of claim 1 wherein the stacked structure covers only a portion of the substrate, the method further comprising:
providing a cover over the portion of the substrate to cover the stacked structure; and
sealing the cover to the substrate;
wherein the cover is provided with ports to circulate the semi-solid electrolyte; and
wherein an anode for the deposition of the nanowires extends through the cover.
